(19) United States
(12) Patent Application Publication
(10) Pub. No.: US 2013/0326427 A1
(43) Pub. Date: Dec. 5, 2013

(54) AUTOMATED ASSESSMENT OF USER INTERFACES

(71) Applicants: Filip Eliás, Vysni Lhoty (CZ); Filip Nguyen, Brno (CZ)

(72) Inventors: Filip Eliás, Vysni Lhoty (CZ); Filip Nguyen, Brno (CZ)

(73) Assignee: Red Hat, Inc., Raleigh, NC (US)

(21) Appl. No.: 13/484,000

(22) Filed: May 30, 2012

(51) Int. Cl. G06F 3/048

(52) U.S. Cl. 715/854

(57) ABSTRACT

A system and method for assessing the effectiveness of a user interface (UI) are disclosed. In accordance with one embodiment, a computer system identifies shortest paths in a directed graph that corresponds to a user interface (UI), obtains a tree from the directed graph, computes an average distance from the root of the tree to a leaf of the tree, and when the average distance exceeds a desired average distance by more than a positive threshold value, provides to a user a message that identifies one or more nodes of the tree and that indicates that navigation to UI states corresponding to these nodes should be modified to reduce the average distance.

### TECHNICAL FIELD

This disclosure relates to computer systems, and more particularly, to user interfaces.

### BACKGROUND

A user interface (UI) is a means by which a user interacts with a computer application. Typically a user interface enables a user to provide input to the computer application (e.g., via a keyboard, a mouse, a microphone, etc.) and the computer application to provide output to the user (e.g., via a display, a speaker, etc.).

A user interface may include a plurality of states; for example, a graphical user interface (GUI) may include a plurality of screens (or web pages in a browser-based application), each corresponding to a respective state. As another example, a computer telephony integration (CTI) application may include a plurality of voice-activated menus, each corresponding to a respective state of the user interface.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1A depicts an illustrative directed graph corresponding to a user interface, in accordance with some embodiments of the present invention.

FIG. 1B depicts an illustrative tree obtained from directed graph 100 of FIG. 1A, in accordance with some embodiments of the present invention.

FIG. 1C depicts an illustrative modification to tree 110 of FIG. 1B, in accordance with some embodiments of the present invention.

FIG. 2 depicts an exemplary system architecture, in accordance with an embodiment of the present invention.

FIG. 3 depicts a block diagram of one embodiment of a user interface manager.

FIG. 4 depicts a flow diagram of one embodiment of a method for assessing a user interface and providing feedback to a user.

FIG. 5 depicts a block diagram of an illustrative computer system operating in accordance with embodiments of the invention.

### DETAILED DESCRIPTION

Described herein is a system and method for assessing a user interface. More particularly, in one embodiment, a directed graph is used to model the states of the user interface, and a tree is obtained from the directed graph and the set of shortest paths from the starting node of the graph (e.g., the node corresponding to the initial state of the user interface) to every other node of the graph. In one embodiment, a distance metric for the tree is then computed and compared to a desired value that has been found to equate to an effective, easily-navigable user interface. For example, a tree with too large of a distance metric may indicate that the tree is too “deep,” and that a user will often have to navigate through many states (e.g., screens, menus, etc.) in order to reach a particular destination state of the corresponding UI. Conversely, a tree with too small of a distance metric may indicate that the tree is too “fat” (i.e., on average a node has a large number of children), and that, as a result, a user may find it confusing to navigate through the corresponding UI because there are often a large number of navigation options available in one or more states (e.g., a menu in a CTI application with a dozen options, etc.).

In accordance with one embodiment of the present disclosure, the distance metric is a normalized average distance from the root to a leaf of the tree, and when the distance metric differs from the desired value by more than a given amount, a message is provided to a user (e.g., a UI developer, etc.) that identifies one or more nodes of the tree (or equivalently, states of the UI) and indicates that navigation to these nodes/states should be modified in order to reduce the difference between the distance metric and the desired value. More particularly, when the distance metric for the tree exceeds the desired value by a given amount, the message indicates that the topology of the tree should be revised by modifying navigation to the identified node(s) (e.g., by moving the identified nodes to a different position in the tree, etc.) so that the distance metric will be reduced. Conversely, when the distance metric for the tree is too small, the message indicates that navigation to the identified node(s) should be modified so that the distance metric is increased.

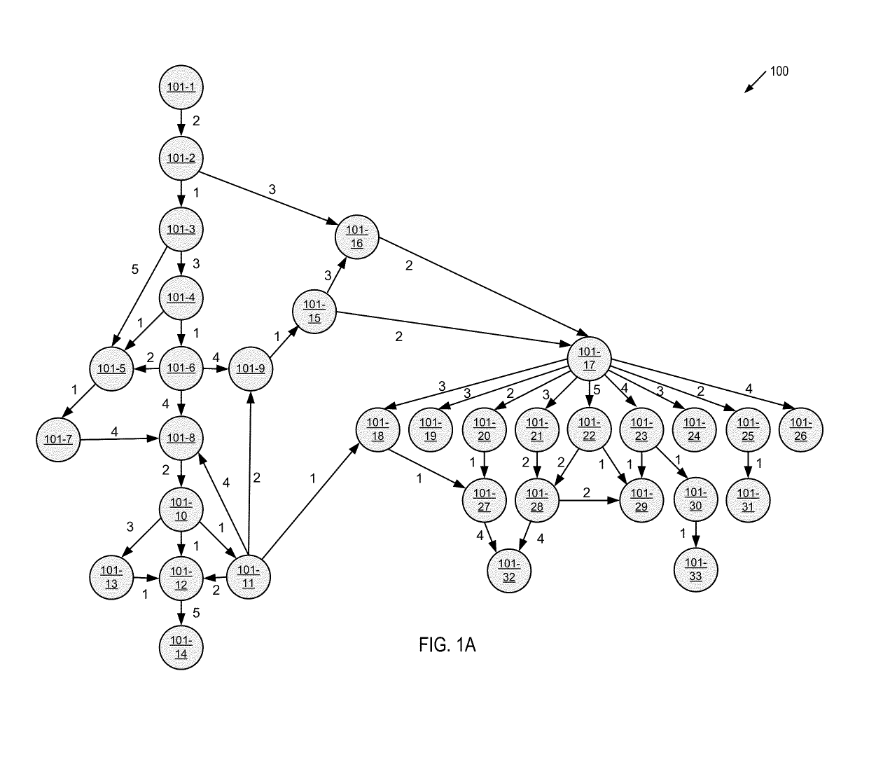

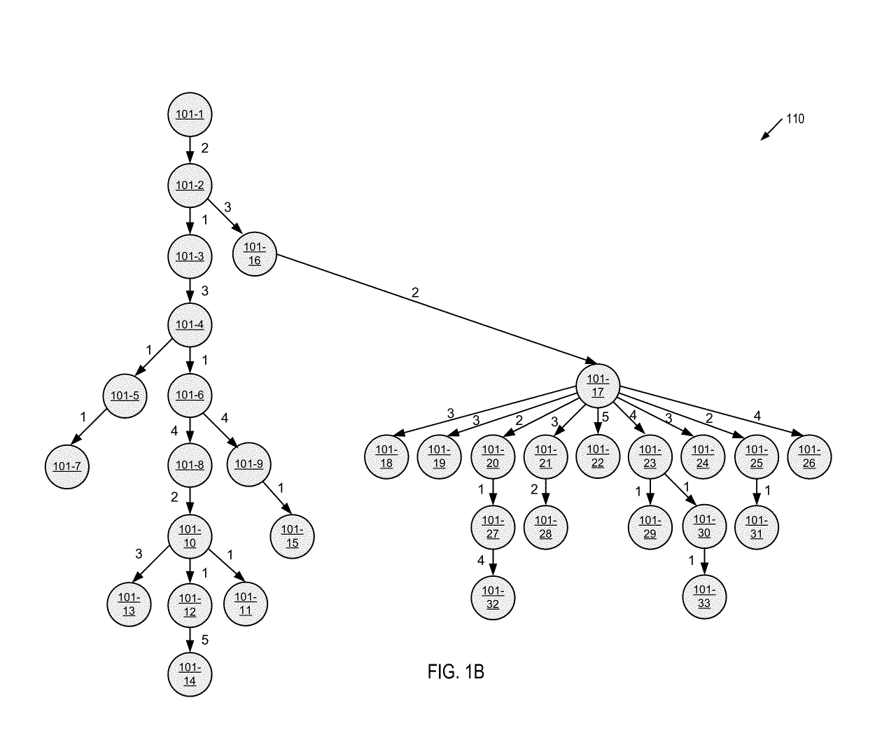

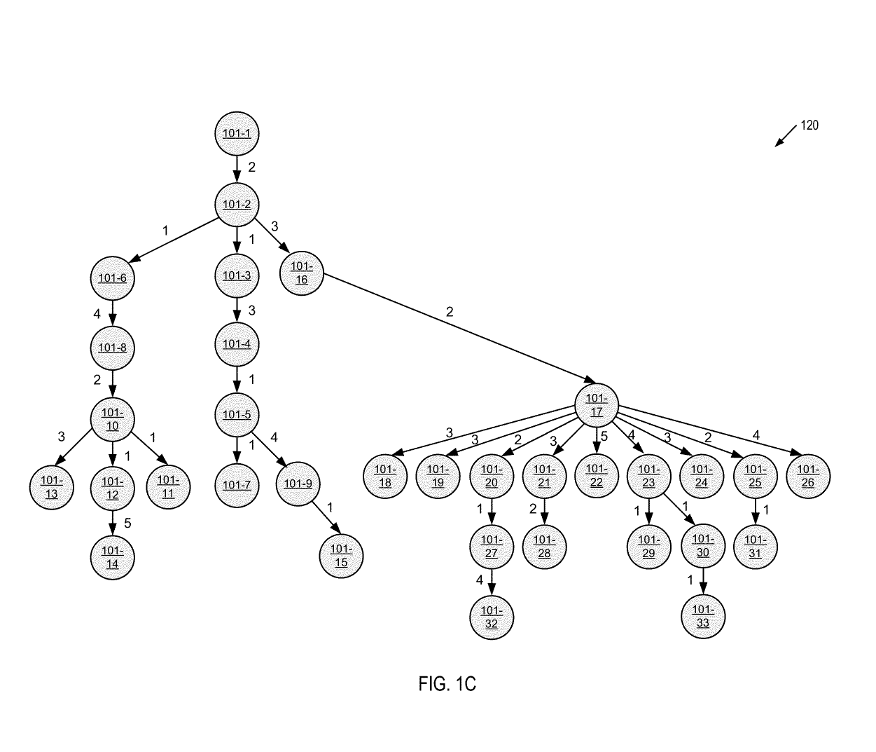

In order to facilitate understanding of the operation of the method, an illustrative example is depicted in FIGS. 1A, 1B, and 1C. FIG. 1A depicts an illustrative directed graph 100 corresponding to a user interface, in accordance with some embodiments of the present invention. As shown in FIG. 1A, directed graph 100 comprises nodes 101-1 through 101-33, each corresponding to a respective state of the user interface (e.g., a screen or web page of a graphical user interface [GUI], a menu of a computer telephony integration [CTI] application, etc.). Each directed edge from a first node 101-i to a second node 101-j indicates that the UI state corresponding to the second node can be reached directly from the UI state corresponding to the first node (e.g., via a button in a graphical user interface [GUI], via a hyperlink in a browser-based GUI, via a user pressing the ‘1’ key of his or her phone or saying the word ‘one’ in a CTI application, etc.).

In one embodiment, each directed edge has an associated weight that is a positive real number, and whose value is based on an expected time duration that a user spends in the first UI state before navigating to the second UI state. For example, the directed edge from node 101-2 to node 101-16 has an associated weight of 3, which indicates that when a user navigates from the state corresponding to node 101-2 to the state corresponding to node 101-16 (e.g., via a button, via a hyperlink, etc.), the user is expected to have spent 3 units of time (e.g., seconds, minutes, etc.) in the state corresponding to node 101-2 prior to navigating to the state corresponding to node 101-16. It should be noted that in some embodiments, edge weights may be determined empirically based on the behavior of a single user, or of a plurality of users, while in some other embodiments, the edge weights may be assigned on a predictive basis, rather than empirically (e.g., based on the complexity of a GUI screen, etc.)

FIG. 1B depicts an illustrative tree 110 that is obtained from directed graph 100 of FIG. 1A, in accordance with some embodiments of the present invention. Tree 110 comprises all 33 nodes of directed graph 100, and has 32 of the edges of directed graph 100. In particular, the 32 edges of tree 110 are edges that connect node 101-1 to each of the other nodes via a shortest path, where the distance from node 101-1 to another node 101-i equals the sum of the weights of the edges along the path from node 101-1 to 101-i. Tree 110 can be obtained from directed graph 100 by computing the shortest path from node 101-1 to each of the other nodes (e.g., via Dijkstra's shortest-path algorithm, etc.), and, during the computation of the shortest paths, storing, for each node, the previous node (or “parent”) on the shortest path.

FIG. 1C depicts an illustrative modification to tree 110, in accordance with some embodiments of the present invention. In particular, a modified tree 120 is obtained from tree 110 by (i) moving the subtree containing nodes 101-9 and 101-10 to be a child of node 101-5, and (ii) moving the subtree containing nodes 101-6, 101-8, and 101-10 through 101-14 to be a child of node 101-2. In instances where the UI corresponding to the original tree 110 might be considered too complex for a user to navigate effectively, due to the long distance from node 101-1 to nodes 101-11 through 101-14, a user interface corresponding to modified tree 120 might be considered preferable.

Embodiments of the present disclosure thus provide a mechanism by which the navigability of a user interface, and hence its user-friendliness and effectiveness, can be assessed in an objective, efficient manner. In addition, embodiments of the present disclosure can provide specific feedback to a user (e.g., a UI developer, etc.) that identifies particular deficiencies of the user interface, and indicates how the user can modify the UI to correct these deficiencies. Advantageously, embodiments of the present disclosure may be applicable to all types of user interfaces, such as graphical user interfaces (GUIs), voice-activated menu interfaces in computer telephony integration (CTI) applications, and so forth.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “determining”, “computing”, “obtaining”, “providing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

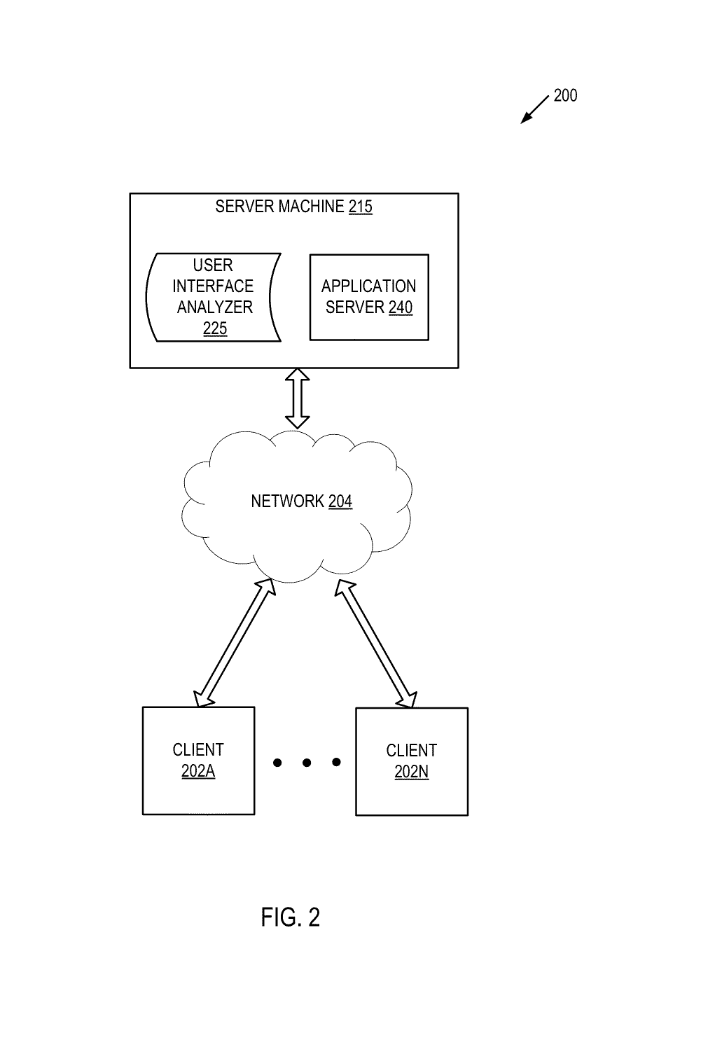

FIG. 2 depicts an exemplary system architecture 200, in accordance with an embodiment of the present invention. The system architecture 200 includes a server machine 215 and client machines 202A-202N connected via a network 204. The client machines 202A-202N may be personal computers (PC), laptops, mobile phones, tablet computers, or any other computing devices. The client machines 202A-202N may run an operating system (OS) that manages hardware and software of the client machines 202A-202N, and a browser that can access web pages of a web server and web pages of a web-based application served by an application server. Network 204 may be a public network (e.g., the Internet), a private network (e.g., a local area network (LAN) or wide area network (WAN)), or a combination thereof.

Server machine 215 may be a rackmount server, a router computer, a personal computer, a portable digital assistant, a mobile phone, a laptop computer, a tablet computer, a camera, a video camera, a netbook, a desktop computer, a media center, or any combination of the above. Server machine 215 includes an application server 240 and a user interface analyzer 225. In alternative embodiments, the application server 240 and user interface analyzer 225 may run on different machines.

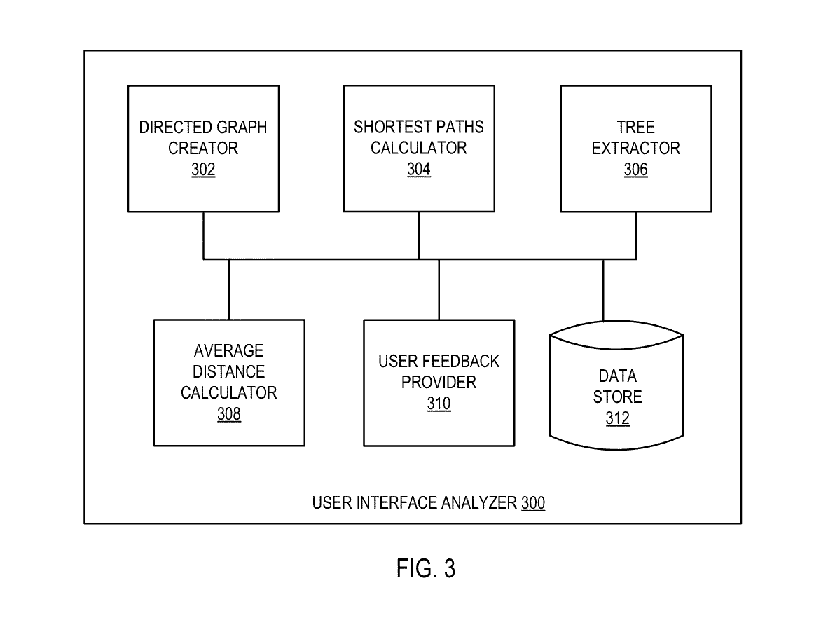

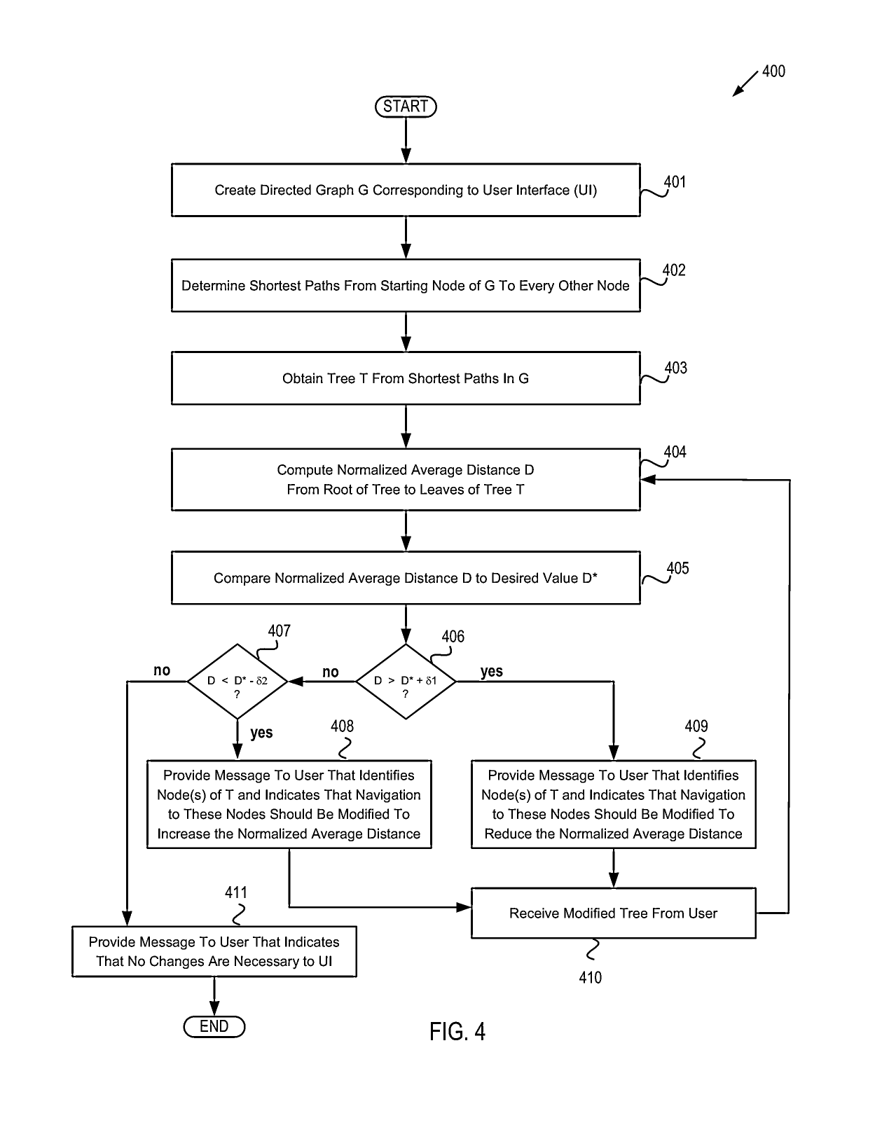

Application server 240 hosts a software application, serves user interface (UI) web pages of the application to clients 202A-202N, and receives input from clients 202A-202N via the UI web pages. In accordance with some embodiments, user interface analyzer 225 assesses the user interface of the application hosted by application server 240 and provides feedback, as necessary, to a user (e.g., a UI developer, etc.) that indicates how the effectiveness of the UI may be improved. An embodiment of user interface analyzer 225 is described in detail below and with respect to FIGS. 3 and 4.

FIG. 3 is a block diagram of one embodiment of a user interface analyzer 300. The user interface analyzer 300 may be the same as the user interface analyzer 225 of FIG. 2 and may include a directed graph creator 302, a shortest paths calculator 304, a tree extractor 306, an average distance calculator 308, a user feedback provider 310, and a data store 312.

The data store 312 may be a temporary buffer or a permanent data store to hold web pages, data structures (e.g., directed graphs and trees corresponding to a user interface, etc.), information associated with applications hosted by application server 240, or some combination of these data. Alternatively, data store 312 may be hosted by one or more storage devices, such as main memory, magnetic or optical storage based disks, tapes or hard drives, NAS, SAN, and so forth.

The directed graph creator 302 constructs a directed graph based on links among web pages of an application hosted by application server 240. In some embodiments, weights for the edges of the directed graph may be determined based on empirical data pertaining to user navigation of the application, while in some other embodiments, weights may be determined based on the content and complexity of the web pages, while in yet other embodiments a UI developer may provide the weights.

The shortest paths calculator 304 determines shortest paths from the starting node of the directed graph (e.g., the node corresponding to the initial state of the corresponding user interface) to every other node of the graph (e.g., via Dijkstra's algorithm, via Floyd's algorithm, etc.). The tree extractor 306 obtains a tree from the directed graph based on the shortest paths determined by shortest paths calculator 304.

The average distance calculator 308 computes an average distance metric for the tree obtained by tree extractor 306. In one embodiment, the average distance metric is a normalized average distance from the root of the tree (e.g., the starting node of the graph) to a leaf of the tree. For example, the normalized average distance D of a tree T may be computed as follows:

$$D = \frac{{\sum }_{L ∈ leaves ( T )} dist ( root , L )}{\vert leaves ( T ) \vert \cdot {\sum }_{e ∈ edges ( T )} w ( e )}$$

where dist(root, L) is the distance from the root to leaf L, w(e) is the weight of edge e, and |leaves(T)| is the number of leaves in tree T. The normalized average distance D and the operation of average distance calculator 308 is described in more detail below with respect to FIG. 4.

The user feedback provider 310 compares the normalized average distance D to a desired value and, when the difference between these two values exceeds a given amount, identifies one or more nodes of the tree and provides a message to a user (e.g., a UI developer, etc.) that indicates that navigation to the identified node(s) should be modified to reduce this difference. The operation of user feedback provider 310 is described in more detail below with respect to FIG. 4.

FIG. 4 depicts a flow diagram of one embodiment of a method 400 for for assessing a user interface and providing feedback to a user. The method is performed by processing logic that may comprise hardware (circuitry, dedicated logic, etc.), software (such as is run on a general purpose computer system or a dedicated machine), or a combination of both. In one embodiment, the method is performed by the computer system 100 of FIG. 1, while in some other embodiments, some or all of the method might be performed by another machine. It should be noted that blocks depicted in FIG. 4 can be performed simultaneously or in a different order than that depicted.

At block 401, a directed graph G corresponding to a user interface (UI) is created. In one embodiment, block 401 is performed by directed graph creator 302.

At block 402, shortest paths from the starting node of graph G (which corresponds to the initial state of the user interface) to every other node of the graph is determined (e.g., via Dijkstra's algorithm, via Floyd's algorithm, etc.) In one embodiment, the algorithm for determining shortest paths is implemented so that, for every node, the previous node on the shortest path from the starting node (i.e., the node's parent) is recorded; as described above, this facilitates derivation of the shortest-path tree, which is performed at block 403 below. In one embodiment, block 402 is performed by shortest paths calculator 304.

At block 403, a tree T is obtained from the shortest paths in graph G. In one embodiment, block 403 is performed by tree extractor 306.

At block 404, a normalized average distance D from the root of tree T to a leaf of tree T is computed. In one embodiment, D is computed as follows:

$$D = \frac{{\sum }_{L ∈ leaves ( T )} dist ( root , L )}{\vert leaves ( T ) \vert \cdot {\sum }_{e ∈ edges ( T )} w ( e )}$$

where dist(root, L) is the distance from the root to leaf L, w(e) is the weight of edge e, and |leaves(T)| is the number of leaves in tree T. Intuitively, D equals the sum of the distances from the root to each of the leaves, divided by the number of leaves to obtain an average distance to a leaf, and then further divided by the sum of all of the edge weights in the tree to normalize the value between 0 and 1. In one embodiment, block 404 is performed by average distance calculator 308.

At block 405, the normalized average distance D is compared to a desired value D*. In one embodiment, D* is defined to be 1/7 (i.e., approximately 0.143), a value that the applicants have found empirically to equate to an easily-navigable user interface. In one embodiment, block 405 is performed by user feedback provider 310.

Block 406 branches based on whether D exceeds (D*+δ₁), where δ₁ is a positive threshold value selected by a user (e.g., an administrator of server machine 115, etc.). If not, execution proceeds to block 407, otherwise execution continues at block 409.

Block 407 branches based on whether D is less than (D*−δ₂), where δ₂ is a positive threshold value selected by a user (note that δ₂ may or may not be the same as δ₁). If so, execution proceeds to block 408, otherwise execution continues at block 411.

At block 408, a message is provided to a user, where the message identifies one or more nodes of tree T (or equivalently, one or more states of the UI) and indicates that navigation to these nodes should be modified in order to increase the normalized average distance metric. In one embodiment, the one or more nodes are determined by (1) determining which leaf has the furthest distance from the root, (2) selecting an ancestor of this leaf (e.g., a parent, a grandparent, a great-grandparent, etc.), and (3) identifying the nodes of the subtree that is rooted at this ancestor. It should be noted that in some other embodiments, the one or more nodes of tree T may be identified in some other fashion.

In one embodiment, block 408 is performed by user feedback provider 310. After block 408, execution continues at block 410.

At block 409, a message is provided to a user, where the message identifies one or more nodes of tree T (or equivalently, one or more states of the UI) and indicates that navigation to these nodes should be modified in order to decrease the normalized average distance metric. In one embodiment, the one or more nodes are determined by (1) determining which node in tree T has the most number of children, and (2) identifying the nodes of the subtree that is rooted at this node. It should be noted that in some other embodiments, the one or more nodes of tree T may be identified in some other fashion.

In one embodiment, block 409 is performed by user feedback provider 310. After block 409, execution proceeds to block 410.

At block 410, a modified tree is received from the user, and execution continues back at block 404 for a subsequent assessment of the corresponding modified UI. At block 411, a message is provided to a user that indicates that no changes are necessary to the user interface. In one embodiment, block 411 is performed by user feedback provider 310.

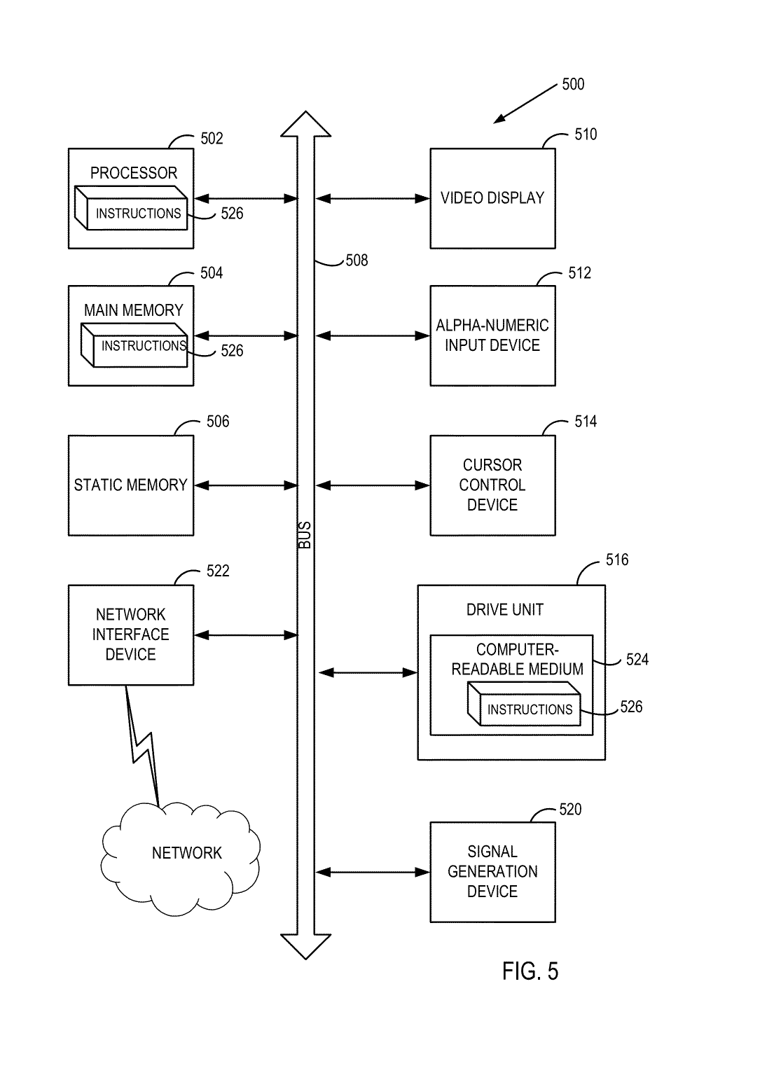

FIG. 5 illustrates an exemplary computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing system (processor) 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 516, which communicate with each other via a bus 506.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations and steps discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a computer-readable medium 524 on which is stored one or more sets of instructions 526 (e.g., instructions corresponding to the methods of FIGS. 2 through 5, etc.) embodying any one or more of the methodologies or functions described herein. Instructions 526 may also reside, completely or at least partially, within the main memory 504 and/or within the processor 502 during execution thereof by the computer system 500, the main memory 504 and the processor 502 also constituting computer-readable media. Instructions 526 may further be transmitted or received over a network via the network interface device 522.

While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
identifying, by a computer system, at least N shortest paths in a directed graph, wherein the directed graph has N nodes, each corresponding to a respective state of a user interface (UI), and wherein a directed edge from a first node to a second node indicates that a UI state corresponding to the second node can be reached directly from a UI state corresponding to the first node;
obtaining from the directed graph, by the computer system, a tree comprising the N nodes and N-1 edges, wherein one of the nodes of the tree is a root, and wherein each of the N-1 edges belongs to at least one of the N shortest paths;
computing, by the computer system, an average distance from the root to a leaf of the tree; and
when the average distance exceeds a desired average distance by more than a first positive threshold value, providing to a user a message that identifies a first set of one or more nodes of the tree and indicates that navigation to UI states corresponding to the first set of nodes should be modified to reduce the average distance.

2. The method of claim 1 wherein the first set of nodes comprises a leaf of the tree with a distance to the root at least as great as that of any other leaf of the tree.

3. The method of claim 1 wherein a weight of the directed edge from the first node to the second node is based on an expected time duration that a user spends in the first UI state before navigating to the second UI state.

4. The method of claim 1 wherein the average distance from the root to a leaf of the tree is normalized with respect to the sum of weights over all edges of the tree.

5. The method of claim 1 wherein the UI is a graphical user interface (GUI) and each UI state corresponds to a respective web page of the GUI.

6. The method of claim 1 further comprising:
when the desired average distance exceeds the average distance from the root to a leaf of the tree by more than a second positive threshold value, providing to the user a message that identifies a second set of one or more nodes and indicates that navigation to UI states corresponding to the second set of nodes should be modified to increase the average distance.

7. The method of claim 6 wherein the second set of nodes comprises a node with at least as many children as that of any other node of the tree.

8. The method of claim 4 wherein the first positive threshold value and the second positive threshold value are equal.

9. The method of claim 4 further comprising:
when the average distance from the root to a leaf of the tree does not exceed the desired average distance by more than the first positive threshold value, and the desired average distance does not exceed the average distance from the root to a leaf of the tree by more than the second positive threshold value, providing to the user a message that indicates that no changes to navigation among UI states are necessary.

10. An apparatus comprising:
a memory to store a directed graph; and
a processor to:
identify at least N shortest paths in a directed graph, wherein the directed graph has N nodes, each corresponding to a respective state of a user interface (UI), and wherein a directed edge from a first node to a second node indicates that a UI state corresponding to the second node can be reached directly from a UI state corresponding to the first node;
obtain a tree from the directed graph, wherein the tree comprises the N nodes and N-1 edges, wherein one of the nodes of the tree is a root, and wherein each of the N-1 edges belongs to at least one of the N shortest paths;
compute an average distance from the root to a leaf of the tree; and
when the desired average distance exceeds the average distance from the root to a leaf of the tree by more than a first positive threshold value, providing to the user a message that identifies one or more nodes of the tree and indicates that navigation to UI states corresponding to the one or more nodes should be modified to increase the average distance.

11. The apparatus of claim 10 wherein the one or more nodes comprises a node with at least as many children as that of any other node of the tree.

12. The apparatus of claim 10 wherein a weight of the directed edge from the first node to the second node is based on an expected time duration that a user spends in the first UI state before navigating to the second UI state.

13. The apparatus of claim 10 wherein the average distance from the root to a leaf of the tree is normalized with respect to the sum of weights over all edges of the tree.

14. The apparatus of claim 10 wherein the processor is also to:
when the desired average distance does not exceed the average distance from the root to a leaf of the tree by more than the first positive threshold value, and the average distance from the root to a leaf of the tree does not exceed the desired average distance by more than a second positive threshold value, providing to the user a message that indicates that no changes to navigation among UI states are necessary.

15. The apparatus of claim 14 wherein the first positive threshold value and the second positive threshold value are equal.

16. The apparatus of claim 10 wherein the UI is a graphical user interface (GUI) and each UI state corresponds to a respective web page of the GUI.

17. A non-transitory computer readable storage medium, having instructions stored therein, which when executed, cause a computer system to perform a method comprising:
identifying, by a computer system, at least N shortest paths in a directed graph, wherein the directed graph has N nodes, each corresponding to a respective state of a user interface (UI), and wherein a directed edge from a first node to a second node indicates that a UI state corresponding to the second node can be reached directly from a UI state corresponding to the first node;
obtaining from the directed graph, by the computer system, a tree comprising the N nodes and N-1 edges, wherein one of the nodes of the tree is a root, and wherein each of the N-1 edges belongs to at least one of the N shortest paths;
computing, by the computer system, an average distance from the root to a leaf of the tree; and
when the desired average distance does not exceed the average distance from the root to a leaf of the tree by more than a first positive threshold value, and the average distance from the root to a leaf of the tree does not exceed the desired average distance by more than a second positive threshold value, providing to the user a message that indicates that no changes to navigation among UI states are necessary.

18. The non-transitory computer readable storage medium of claim 17 wherein a weight of the directed edge from the first node to the second node is based on an expected time duration that a user spends in the first UI state before navigating to the second UI state.

19. The non-transitory computer readable storage medium of claim 17 wherein the average distance from the root to a leaf of the tree is normalized with respect to the sum of weights over all edges of the tree.

20. The non-transitory computer readable storage medium of claim 17 wherein the UI is a graphical user interface (GUI) and each UI state corresponds to a respective web page of the GUI.
